(19) United States
(12) Patent Application Publication
(10) Pub. No.: US 2010/0214544 A1
(43) Pub. Date: Aug. 26, 2010

(54) FLUID HANDLING DEVICE, AN IMMERSION LITHOGRAPHIC APPARATUS AND A DEVICE MANUFACTURING METHOD

(75) Inventors: Harry Sewell, Ridgefield, CT (US); Sjoerd Nicolaas lambertus Donders, Vught (NL); Louis John Markoya, Sandy Hook, CT (US); Diane McCafferty, Sandy Hook, CT (US); Ralph Joseph Meijers, Kerkrade (NL)

Correspondence Address: PILLSBURY WINTHROP SHAW PITTMAN, LLP, P.O. BOX 10500, MCLEAN, VA, 22102, US

(73) Assignees: ASML Holding N.V., Veldhoven (NL); ASML Netherlands B.V., Veldhoven (NL)

(21) Appl. No.: 12/711,825

(22) Filed: Feb. 24, 2010

Related U.S. Application Data
(60) Provisional application No. 61/155,403, filed on Feb. 25, 2009.

(51) Int. Cl. G03B 27/52

(52) U.S. Cl. 355/30

(57) ABSTRACT

A fluid handling device for an immersion lithographic apparatus, the fluid handling device comprising: at least one body with a surface facing a space for fluid; a plurality of openings for the flow of fluid therethrough defined in the surface; at least one barrier moveable relative to the plurality of openings for selectively allowing or preventing the flow of fluid through selected openings of the plurality of openings.

This application claims priority and benefit under 35 U.S.C. §119(e) to U.S. Provisional Patent Application No. 61/155,403, entitled “A Fluid Handling Device, An Immersion Lithographic Apparatus and A Device Manufacturing Method”, filed on Feb. 25, 2009. The content of that application is incorporated herein in its entirety by reference.

### FIELD

The present invention relates to a fluid handling device, an immersion lithographic apparatus and a device manufacturing method.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

It has been proposed to immerse the substrate in the lithographic projection apparatus in a liquid having a relatively high refractive index, e.g. water, so as to fill a space between the final element of the projection system and the substrate. In an embodiment, the liquid is distilled water, although another liquid can be used. An embodiment of the present invention will be described with reference to liquid. However, another fluid may be suitable, particularly a wetting fluid, an incompressible fluid and/or a fluid with higher refractive index than air, desirably a higher refractive index than water. Fluids excluding gases are particularly desirable. The point of this is to enable imaging of smaller features since the exposure radiation will have a shorter wavelength in the liquid. (The effect of the liquid may also be regarded as increasing the effective numerical aperture (NA) of the system and also increasing the depth of focus.) Other immersion liquids have been proposed, including water with solid particles (e.g. quartz) suspended therein, or a liquid with a nano-particle suspension (e.g. particles with a maximum dimension of up to 10 nm). The suspended particles may or may not have a similar or the same refractive index as the liquid in which they are suspended. Other liquids which may be suitable include a hydrocarbon, such as an aromatic, a fluorohydrocarbon, and/or an aqueous solution.

Submersing the substrate or substrate and substrate table in a bath of liquid (see, for example, U.S. Pat. No. 4,509,852) means that there is a large body of liquid that must be accelerated during a scanning exposure. This requires additional or more powerful motors and turbulence in the liquid may lead to undesirable and unpredictable effects.

In an immersion apparatus, immersion fluid is handled by a fluid handling system, device, structure or apparatus. In an embodiment the fluid handling system may supply immersion fluid and therefore be a fluid supply system. In an embodiment the fluid handling system may at least partly confine immersion fluid and thereby be a fluid confinement system. In an embodiment the fluid handling system may provide a barrier to immersion fluid and thereby be a barrier member, such as a fluid confinement structure. In an embodiment the fluid handling system may create or use a flow of gas, for example to help in controlling the flow and/or the position of the immersion fluid. The flow of gas may form a seal to confine the immersion fluid so the fluid handling structure may be referred to as a seal member; such a seal member may be a fluid confinement structure. In an embodiment, immersion liquid is used as the immersion fluid. In that case the fluid handling system may be a liquid handling system. In reference to the aforementioned description, reference in this paragraph to a feature defined with respect to fluid may be understood to include a feature defined with respect to liquid.

One of the arrangements proposed is for a liquid supply system to provide liquid on only a localized area of the substrate and in between the final element of the projection system and the substrate using a liquid confinement system (the substrate generally has a larger surface area than the final element of the projection system). One way which has been proposed to arrange for this is disclosed in WO 99/49504. As illustrated in FIGS. 2 and 3, liquid is supplied by at least one inlet onto the substrate, desirably along the direction of movement of the substrate relative to the final element, and is removed by at least one outlet after having passed under the projection system. That is, as the substrate is scanned beneath the element in a −X direction, liquid is supplied at the +X side of the element and taken up at the −X side. FIG. 2 shows the arrangement schematically in which liquid is supplied via inlet and is taken up on the other side of the element by outlet which is connected to a low pressure source. The arrows above the substrate W illustrate the direction of liquid flow, and the arrow below the substrate W illustrates the direction of movement of the substrate table. In the illustration of FIG. 2 the liquid is supplied along the direction of movement of the substrate relative to the final element, though this does not need to be the case. Various orientations and numbers of in- and out-lets positioned around the final element are possible, one example is illustrated in FIG. 3 in which four sets of an inlet with an outlet on either side are provided in a regular pattern around the final element. Arrows in liquid supply and liquid recovery devices indicate the direction of liquid flow.

A further immersion lithography solution with a localized liquid supply system is shown in FIG. 4. Liquid is supplied by two groove inlets on either side of the projection system PS and is removed by a plurality of discrete outlets arranged radially outwardly of the inlets. The inlets and outlets can be arranged in a plate with a hole in its center and through which the projection beam is projected. Liquid is supplied by one groove inlet on one side of the projection system PS and removed by a plurality of discrete outlets on the other side of the projection system PS, causing a flow of a thin film of liquid between the projection system PS and the substrate W. The choice of which combination of inlet and outlets to use can depend on the direction of movement of the substrate W (the other combination of inlet and outlets being inactive). In the cross-sectional view of FIG. 4, arrows illustrate the direction of liquid flow in inlets and out of outlets.

In European patent application publication no. EP 1420300 and United States patent application publication no. US 2004-0136494, each hereby incorporated in their entirety by reference, the idea of a twin or dual stage immersion lithography apparatus is disclosed. Such an apparatus is provided with two tables for supporting a substrate. Leveling measurements are carried out with a table at a first position, without immersion liquid, and exposure is carried out with a table at a second position, where immersion liquid is present. Alternatively, the apparatus has only one table.

PCT patent application publication WO 2005/064405 discloses an all wet arrangement in which the immersion liquid is unconfined. In such a system the whole top surface of the substrate is covered in liquid. This may be advantageous because then the whole top surface of the substrate is exposed to the substantially same conditions. This has an advantage for temperature control and processing of the substrate. In WO 2005/064405, a liquid supply system provides liquid to the gap between the final element of the projection system and the substrate. That liquid is allowed to leak (or flow) over the remainder of the substrate. A barrier at the edge of a substrate table prevents the liquid from escaping so that it can be removed from the top surface of the substrate table in a controlled way. Although such a system improves temperature control and processing of the substrate, evaporation of the immersion liquid may still occur. One way of helping to alleviate that problem is described in United States patent application publication no. US 2006/0119809. A member is provided which covers the substrate in all positions and which is arranged to have immersion liquid extending between it and the top surface of the substrate and/or substrate table which holds, the substrate.

### SUMMARY

One difficulty with immersion technology, particularly high NA immersion technology in which a high refractive index (high n) fluid is used, is the variation in refractive index with temperature of the immersion fluid. Even a temperature change of 3 mK can lead to aberrations such as focus shift, spherical aberrations, and/or non-symmetrical aberrations such as coma. High refractive index immersion fluids generally comprise a hydrocarbon. Such fluids can break down in the radiation of, e.g., the patterned beam which can lead to the need for cleaning one or more surfaces, such as a surface of the final element of the projection system.

It is desirable, for example, to reduce the effect of temperature variations in immersion fluid and/or reduce the amount of temperature variations in immersion fluid. It is also desirable to provide a system in which the breakdown of immersion fluid due to radiation is reduced.

According to an aspect, there is provided a fluid handling device for an immersion lithographic apparatus, the fluid handling device comprising: a body with a surface surrounding a space for fluid; a plurality of openings for the flow of fluid therethrough defined in the surface; and a barrier moveable relative to the body to selectively allow or prevent flow of fluid through a selected opening, or a selected part of an opening, of the plurality of openings.

According to an aspect, there is provided an immersion lithographic apparatus arranged to provide and extract fluid from a space through an opening at a rate such that fluid in an exposure zone in the space in which exposure zone fluid is irradiated by a beam of radiation during scanning is replenished between the start of adjacent scanning motions.

According to an aspect, there is provided an immersion lithographic apparatus comprising a source of radiation to irradiate with a beam of radiation a substrate through an immersion liquid, the source of radiation configured to produce the beam of radiation with a peak energy of less than 0.3 mJ/cm².

According to an aspect, there is provided a device manufacturing method, comprising projecting a patterned beam of radiation onto a substrate through a fluid provided in a space adjacent the substrate, wherein fluid is provided and extracted from the space at such a rate that fluid in an exposure zone in the space, in which exposure zone fluid is irradiated during scanning, is replenished between the start of adjacent scanning motions.

According to an aspect, there is provided a device manufacturing method, comprising projecting a patterned beam of radiation onto a substrate through a fluid provided in a space adjacent the substrate, wherein a plurality of openings are defined in a surface of a body which surface faces the space and a direction of flow of fluid through the space is adjusted by moving a barrier relative to the plurality of openings.

According to an aspect, there is provided a device manufacturing method, comprising projecting a patterned beam of radiation onto a substrate through a fluid provided in a space adjacent the substrate, wherein the patterned beam of radiation has a peak energy of less than 0.3 mJ/cm².

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIGS. 2 and 3 depict a liquid supply system for use in a lithographic projection apparatus;

FIG. 4 depicts a further liquid supply system for use in a lithographic projection apparatus;

FIG. 5 depicts a further liquid supply system for use in a lithographic projection apparatus;

FIG. 6 illustrates, in plan, a conventional arrangement of a fluid handling device;

FIG. 7 illustrates, in plan, a fluid handling device of an embodiment of the present invention;

FIG. 8 illustrates, schematically and in plan, the change in direction of flow through the immersion space during stepping motion between dies of a substrate under a projection system;

FIG. 9 illustrates, in plan, how a slug of warmed fluid exits from an exposure zone of a fluid supply device of an embodiment of the present invention;

FIG. 10 illustrates, in plan, a barrier and openings of a fluid handling device of an embodiment of the present invention;

FIG. 11 illustrates, schematically, first and second openings and a barrier of a fluid handling device of a further embodiment of the present invention;

FIG. 12 illustrates, schematically, first and second openings and a barrier of a fluid handling device of a further embodiment of the present invention;

FIG. 13 illustrates, in plan, a fluid handling device of an embodiment of the present invention; and

FIG. 14 is a graph showing change in optical density versus total delivered energy for laser radiation sources with different pulse rates.

### DETAILED DESCRIPTION

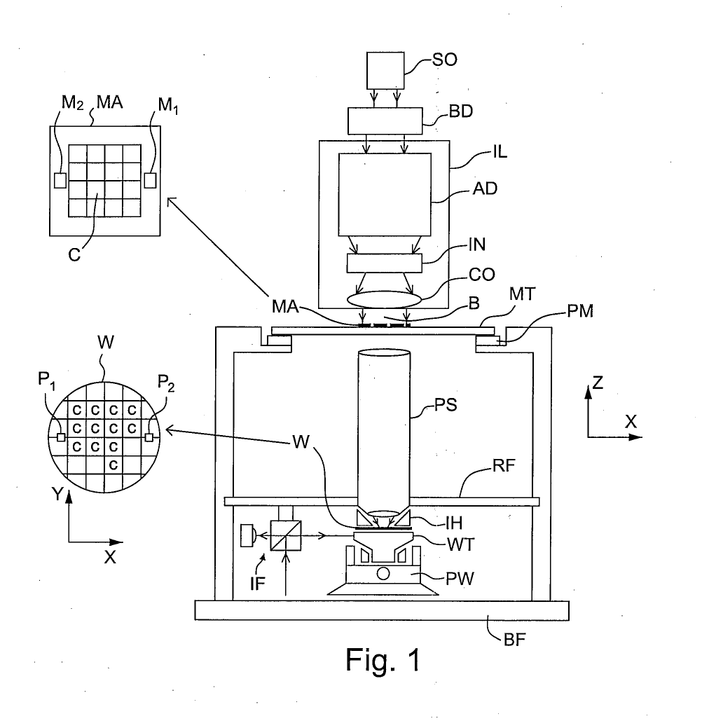

FIG. 1 schematically depicts a lithographic apparatus according to one embodiment of the invention. The apparatus comprises:

an illumination system (illuminator) IL configured to condition a radiation beam B (e.g. UV radiation or DUV radiation);

a support structure (e.g. a mask table) MT constructed to support a patterning device (e.g. a mask) MA and connected to a first positioner PM configured to accurately position the patterning device MA in accordance with certain parameters;

a substrate table (e.g. a wafer table) WT constructed to hold a substrate (e.g. a resist-coated wafer) W and connected to a second positioner PW configured to accurately position the substrate W in accordance with certain parameters; and

a projection system (e.g. a refractive projection lens system) PS configured to project a pattern imparted to the radiation beam B by patterning device MA onto a target portion C (e.g. comprising one or more dies) of the substrate W.

The illumination system IL may include various types of optical components, such as refractive, reflective, magnetic, electromagnetic, electrostatic or other types of optical components, or any combination thereof, for directing, shaping, or controlling radiation.

The support structure MT holds the patterning device MA. It holds the patterning device MA in a manner that depends on the orientation of the patterning device MA, the design of the lithographic apparatus, and other conditions, such as for example whether or not the patterning device MA is held in a vacuum environment. The support structure MT can use mechanical, vacuum, electrostatic or other clamping techniques to hold the patterning device MA. The support structure MT may be a frame or a table, for example, which may be fixed or movable as required. The support structure MT may ensure that the patterning device MA is at a desired position, for example with respect to the projection system PS. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device MA may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof; as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables (and/or two or more patterning device tables). In such “multiple stage” machines the additional tables may be used in parallel, or preparatory steps may be carried out on one or more tables while one or more other tables are being used for exposure.

Referring to FIG. 1, the illuminator IL receives a radiation beam from a radiation source SO. The source SO and the lithographic apparatus may be separate entities, for example when the source SO is an excimer laser. In such cases, the source SO is not considered to form part of the lithographic apparatus and the radiation beam is passed from the source SO to the illuminator IL with the aid of a beam delivery system BD comprising, for example, suitable directing mirrors and/or a beam expander. In other cases the source SO may be an integral part of the lithographic apparatus, for example when the source SO is a mercury lamp. The source SO and the illuminator IL, together with the beam delivery system BD if required, may be referred to as a radiation system.

The illuminator IL may comprise an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator IL can be adjusted. In addition, the illuminator IL may comprise various other components, such as an integrator IN and a condenser CO. The illuminator IL may be used to condition the radiation beam, to have a desired uniformity and intensity distribution in its cross-section. Similar to the source SO, the illuminator IL may or may not be considered to form part of the lithographic apparatus. For example, the illuminator IL may be an integral part of the lithographic apparatus or may be a separate entity from the lithographic apparatus. In the latter case, the lithographic apparatus may be configured to allow the illuminator IL to be mounted thereon. Optionally, the illuminator IL is detachable and may be separately provided (for example, by the lithographic apparatus manufacturer or another supplier).

The radiation beam B is incident on the patterning device (e.g., mask) MA, which is held on the support structure (e.g., mask table) MT, and is patterned by the patterning device MA. Having traversed the patterning device MA, the radiation beam B passes through the projection system PS, which focuses the beam onto a target portion C of the substrate W. With the aid of the second positioner PW and position sensor IF (e.g. an interferometric device, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1) can be used to accurately position the patterning device MA with respect to the path of the radiation beam B, e.g. after mechanical retrieval from a mask library, or during a scan. In general, movement of the support structure MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the support structure MT may be connected to a short-stroke actuator only, or may be fixed. Patterning device MA and substrate W may be aligned using patterning device alignment marks M1, M2 and substrate alignment marks P1, P2. Although the substrate alignment marks as illustrated occupy dedicated target portions, they may be located in spaces between target portions C (these are known as scribe-lane alignment marks). Similarly, in situations in which more than one die is provided on the patterning device MA, the patterning device alignment marks may be located between the dies.

The depicted apparatus could be used in at least one of the following modes:

1. In step mode, the support structure MT and the substrate table WT are kept essentially stationary, while an entire pattern imparted to the radiation beam B is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the radiation beam B is projected onto a target portion C (i.e. a single dynamic exposure). The velocity and direction of the substrate table WT relative to the support structure MT may be determined by the (de-)magnification and image reversal characteristics of the projection system PS. In scan mode, the maximum size of the exposure field limits the width (in the non-scanning direction) of the target portion C in a single dynamic exposure, whereas the length of the scanning motion determines the height (in the scanning direction) of the target portion C.

3. In another mode, the support structure MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

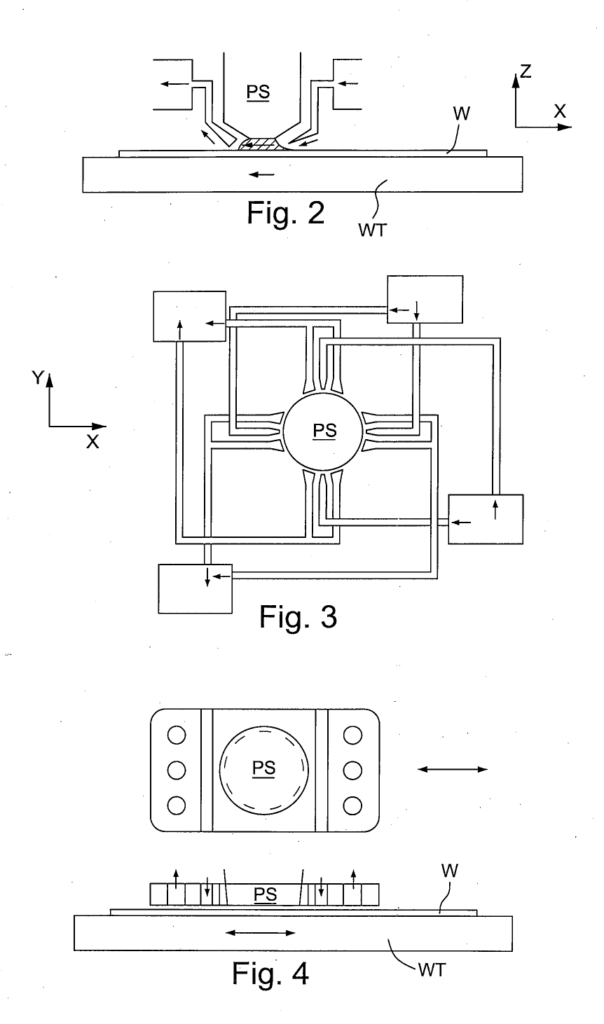

Arrangements for providing liquid between a final element of the projection system and the substrate can be classed into at least two general categories. These are the bath type arrangement in which substantially the whole of the substrate and optionally part of the substrate table is submersed in a bath of liquid and the so called localized immersion system which uses a liquid supply system in which liquid is only provided to a localized area of the substrate. In the latter category, the space filled by liquid is smaller in plan than the top surface of the substrate and the area filled with liquid remains substantially stationary relative to the projection system while the substrate moves underneath that area. A further arrangement, to which an embodiment of the present invention is directed, is the all wet solution in which the liquid is unconfined. In this arrangement substantially the whole top surface of the substrate and all or part of the substrate table is covered in immersion liquid. The depth of the liquid covering at least the substrate is small. The liquid may be a film, such as a thin film, of liquid on the substrate. Any of the liquid supply devices of FIGS. 2-5 may be used in such a system; however, sealing features are not present, are not activated, are not as efficient as normal or are otherwise ineffective to seal liquid to only the localized area. Four different types of localized liquid supply systems are illustrated in FIGS. 2-5. The liquid supply systems disclosed in FIGS. 2-4 were described above.

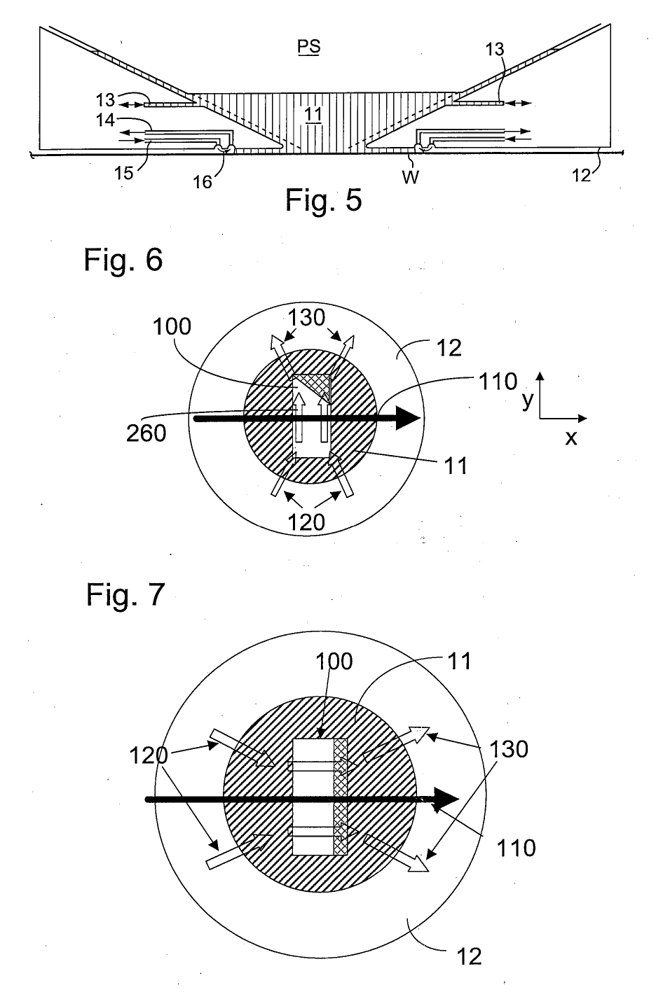

Another arrangement which has been proposed is to provide the liquid supply system with a fluid confinement structure which extends along at least a part of a boundary of the space between the final element of the projection system and the substrate table. Such an arrangement is illustrated in FIG. 5. The fluid confinement structure is substantially stationary relative to the projection system in the XY plane though there may be some relative movement in the Z direction (in the direction of the optical axis). A seal is formed between the fluid confinement structure and the surface of the substrate. In an embodiment, a seal is formed between the fluid confinement structure and the surface of the substrate and may be a contactless seal such as a gas seal. Such a system is disclosed in United States patent application publication no. US 2004-0207824.

FIG. 5 schematically depicts a localized liquid supply system or fluid handling structure or device with a body 12 forming a barrier member or fluid confinement structure, which extends along at least a part of a boundary of the space 11 between the final element of the projection system PS and the substrate table WT or substrate W. (Please note that reference in the following text to surface of the substrate W also refers in addition or in the alternative to a surface of the substrate table WT, unless expressly stated otherwise.) The fluid handling structure is substantially stationary relative to the projection system PS in the XY plane though there may be some relative movement in the Z direction (in the direction of the optical axis). In an embodiment, a seal is formed between the body 12 and the surface of the substrate W and may be a contactless seal such as a gas seal or fluid seal.

The fluid handling device at least partly contains liquid in the space 11 between a final element of the projection system PS and the substrate W. A contactless seal, such as a gas seal 16, to the substrate W may be formed around the image field of the projection system PS so that liquid is confined within the space 11 between the substrate W surface and the final element of the projection system PS. The space 11 is at least partly formed by the body 12 positioned below and surrounding the final element of the projection system PS. Liquid is brought into the space 11 below the projection system PS and within the body 12 by liquid inlet 13. The liquid may be removed by liquid outlet 13. The body 12 may extend a little above the final element of the projection system PS. The liquid level rises above the final element so that a buffer of liquid is provided. In an embodiment, the body 12 has an inner periphery that at the upper end closely conforms to the shape of the projection system PS or the final element thereof and may, e.g., be round. At the bottom, the inner periphery closely conforms to the shape of the image field, e.g., rectangular, though this need not be the case.

The liquid is contained in the space 11 by the gas seal 16 which, during use, is formed between the bottom of the body 12 and the surface of the substrate W. The gas seal 16 is formed by gas, e.g. air or synthetic air but, in an embodiment, N₂ or another inert gas. The gas in the gas seal 16 is provided under pressure via inlet 15 to the gap between body 12 and substrate W. The gas is extracted via outlet 14. The overpressure on the gas inlet 15, vacuum level on the outlet 14 and geometry of the gap are arranged so that there is a high-velocity gas flow inwardly that confines the liquid. The force of the gas on the liquid between the body 12 and the substrate W contains the liquid in a space 11. The inlets/outlets may be annular grooves which surround the space 11. The annular grooves may be continuous or discontinuous. The flow of gas is effective to contain the liquid in the space 11. Such a system is disclosed in United States patent application publication no. US 2004-0207824.

The example of FIG. 5 is a so called localized area arrangement in which liquid is only provided to a localized area of the top surface of the substrate W at any one time. Other arrangements are possible, including fluid handling systems which make use of a single phase extractor (whether or not it works in two phase mode) as disclosed, for example, in United States patent application publication no US 2006-0038968. In an embodiment, a single phase extractor may comprise an inlet which is covered in a porous material which is used to separate liquid from gas to enable single-liquid phase liquid extraction. A chamber downstream of the porous material is maintained at a slight under pressure and is filled with liquid. The under pressure in the chamber is such that the meniscuses formed in the holes of the porous material prevent ambient gas from being drawn into the chamber. However, when the porous surface comes into contact with liquid there is no meniscus to restrict flow and the liquid can flow freely into the chamber. The porous material has a large number of small holes, e.g. of diameter in the range of 5 to 50 μm. In an embodiment, the porous material is at least slightly liquidphilic (e.g., hydrophilic), i.e. having a contact angle of less than 90° to the immersion liquid, e.g. water.

Another arrangement which is possible is one which works on a gas drag principle. The so-called gas drag principle has been described, for example, in United States patent application publication no. US 2008-0212046 and U.S. patent application No. 61/071,621 filed on 8 May 2008. In that system the extraction holes are arranged in a shape which desirably has a corner. The corner may be aligned with the stepping and scanning directions. This reduces the force on the meniscus between two openings in the surface of the fluid handing structure for a given speed in the step or scan direction compared to if the two outlets were aligned perpendicular to the direction of scan. An embodiment of the invention may be applied to a fluid handling structure used in all wet immersion apparatus. In the all wet embodiment, fluid is allowed to cover the whole of the top surface of the substrate table, for example, by allowing liquid to leak out of a confinement structure which confines liquid to between the final element of projection system and the substrate. An example of a fluid handling structure for an all wet embodiment can be found in U.S. patent application no. 61/136,380 filed on 2 Sep. 2008.

Many types of fluid handling structure are arranged to allow a flow of fluid across the space 11 between the final element of the projection system PS and the substrate W in a certain direction. For example, in the fluid handling system of FIGS. 2 and 3, this is achieved by providing a plurality of inlets and outlets surrounding the space and selectively providing or extracting liquid through those inlets or outlets to create the desired flow. In the case of the FIG. 5 embodiment, the liquid outlet 13 may comprise a plurality of openings for the flow of liquid therethrough in the body 12 of the fluid handling device which openings surround the space 11. Liquid can then be provided (or extracted) through those openings to provide a flow across the space 11 in the desired direction. A first set of openings may be provided for the provision of liquid to the space 11 and a second set of openings may be provided for extraction of liquid from the space 11. In the embodiment of FIGS. 2 and 3 (to which an embodiment of the present invention may be directed), the inlet and outlets can be considered as being a plurality of bodies each of which has a surface which is provided with an opening for the flow of liquid therethrough.

It has been suggested that the direction of fluid flow across the space 11 may be varied during scanning. For example, in the embodiment of FIGS. 2 and 3, the liquid flow in the space 11 is in the same direction as the direction of movement of the substrate relative to the projection system PS. This is primarily to help in containment of the liquid in the space 11. In an alternative embodiment, the liquid flow is orthogonal to the scan direction. That is, if scanning occurs in the X direction, then the fluid flow across the space 11 is in the Y direction. This has an advantage that there is no physical difference between scanning in the plus and minus directions i.e. it is not necessary to change the flow direction. This arrangement also has an advantage that it is not necessary to change the direction of flow as the substrate meanders under the projection system PS in many directions. However, a difficulty with such an arrangement may arise due to the high sensitivity of refractive index of immersion liquid to temperature, particularly for a high n immersion liquid/fluid. FIG. 6 illustrates why this is so.

FIG. 6 is a schematic illustration, in plan, of a fluid handling device which provides liquid to the space 11 between the final element of the projection system PS and the substrate W. An exposure zone 100 is illustrated. The exposure zone 100 is in the space 11. The exposure zone 100 is the zone in the space 11 which is irradiated by the beam PB during scanning In the case where liquid flow is orthogonal to the direction of scanning (the direction of scanning is illustrated by arrow 110), immersion liquid is provided, for example, in the space 11 as illustrated by arrows 120 through openings. Immersion liquid then passes through the exposure zone 100 and out of the space 11 as illustrated by arrow 130 through openings 130.

As the liquid passes through the exposure zone 100, it is heated by the beam PB passing through it during scanning. Therefore, liquid in the top right hand corner of the exposure zone 100 as illustrated will be exposed to the beam PB for longest and is therefore likely to be hottest. For example, during stepping between one scanning action (i.e. a first die) and an adjacent scanning action (i.e. a second die) new liquid entering the exposure zone 100 will replace liquid heated during the previous scanning motion. However, at the start of the next scanning motion it is likely that some liquid which was heated in the previous scanning motion will still be present in the exposure zone 100. This is illustrated by the dark area in the top right hand corner of the exposure zone 100 of FIG. 6. Inhomogeneity in liquid temperature can lead to difficulties as described above. This difficulty is aggravated because the exposure zone 100 is typically shorter in the direction of scanning than in the direction orthogonal to scanning.

The presence of immersion liquid with a higher temperature in the top right hand corner of an exposure zone 100 results in the aberration profile changing along the Y-axis of the exposure slit (exposure zone 100). Aberration correction can be applied, to an average degree, but the heating is pattern density dependent and hence changes rapidly. The aberration profile is therefore very difficult to correct consistently. Therefore, while there are minimal thermally induced aberrations at the bottom of the slit or exposure zone 100 (cool in-flow end), the thermally induced aberrations can become severe at the top of the slit or exposure zone 100 (warm out-flow end). The reason for the top right hand corner as illustrated in FIG. 2 of the exposure zone 100 becoming hotter (than the left) is because of liquid drag caused by substrate motion as illustrated by arrow 110.

In an embodiment of the present invention, the lithographic apparatus is arranged to provide and extract liquid from the space 11 at a rate such that liquid in the exposure zone 100, in the space 11 is replenished between the start of adjacent scanning motions (imaging of adjacent dies). That is, the flow is fast enough such that between scanning of adjacent dies liquid which enters the exposure zone at the start of scanning of the first die will have exited the exposure zone 100 before scanning of the second die commences. One way to achieve this without dramatically increasing the flow rate of immersion liquid (which may be undesirable, particularly for a high n immersion fluid because of the required volume) is to change the flow direction to be substantially parallel to the direction in which the substrate moves relative to the projection system PS. In this way the distance which the liquid needs to travel to pass through the exposure zone 100 is greatly reduced (because the exposure zone 100 is elongate in shape with its dimension in the direction of travel of the substrate being smaller than the direction orthogonal to the direction of travel of the substrate W).

Therefore, in an embodiment of the present invention, the temperature distribution in the slit is much more homogeneous. Therefore, it is easier to correct for the variation in temperature in the slit. Furthermore, the effect of the temperature gradient is averaged out by the scan.

FIG. 7 illustrates the above principle which is similar to the principle illustrated in FIG. 2. However, in the FIG. 2 embodiment the liquid in the exposure zone 100 is not replenished between adjacent dies. This is because the speed of provision of liquid is much slower than in an embodiment of the present invention and is of the order of magnitude of the speed of scanning of the substrate W under the projection system PS (i.e. the velocity between the liquid and the substrate is close to zero whereas in an embodiment of the present invention that velocity is much greater than zero). Furthermore, in the embodiment of FIG. 2 the fluid flow is not always in direction of travel of the substrate relative to the projection system. For example, during stepping between lines of adjacent dies, the system of FIGS. 2 and 3 appears not to change the direction of flow to coincide with the direction of travel. That is, as can be seen in FIG. 7, the substrate W is moving in direction 110 and fluid is provided to the exposure zone 100 in direction 120 which is substantially parallel to the direction 110. Fluid is extracted in direction 130 from the exposure zone 100. The velocity of the liquid relative to the projection system is greater than the velocity of the substrate W relative to the projection system. For this reason the position of heated liquid (illustrated by the dark area in the exposure zone 100) moves out of the exposure zone 100 in the same direction as the direction of travel 110 of the substrate W relative to the projection system PS. By the time a second scanning motion has been started, any fluid which entered the exposure zone 100 prior to the start of the previous scanning motion will have left the exposure zone 100. Desirably the fluid in the exposure zone 100 is replenished between finishing of a first scanning motion and commencement of a second scanning motion.

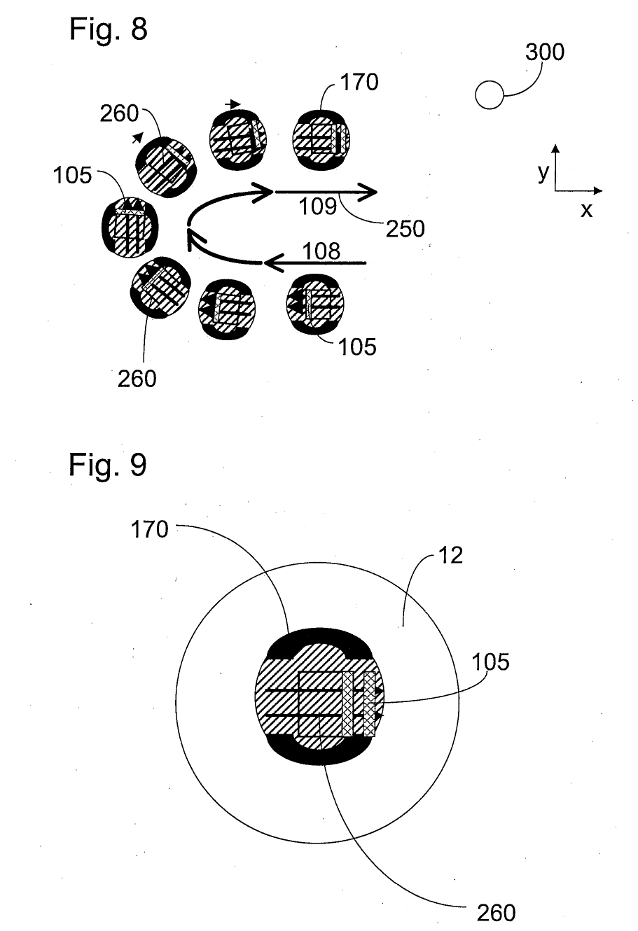

It is advantageous to ensure that the direction 260 of liquid flow through the exposure slit 100 is in substantially the same direction as the direction 250 of travel of the substrate W relative to the projection system PS throughout the meandering path of the substrate W. That is, the direction 260 of liquid flow is substantially the same as the direction 250 of movement of the substrate W under the projection system PS. This is illustrated in FIG. 8 which is a schematic illustration of the movement of the substrate W under the substantially stationary projection system PS and the corresponding movement of a slug of liquid 105 which has been heated during a scan. Therefore, in this embodiment during the time between finishing scanning of a first exposure field or die 108, as the substrate W is moved into position to scan a second field or die 109 which is positioned in the next row, the direction of liquid flow across the space 11 is changed progressively by 180°. In this way the slug of liquid 105 moves out of the exposure zone 100 and possibly even out of the space 11 before scanning of the next field 109 commences.

FIG. 9 illustrates the situation at the start of the exposure of the second field 109 and it can be seen that the slug of liquid 105 (which has now been warmed by the beam PB) is outside of the exposure zone 100 prior to commencement of scanning in the exposure zone 100 for the subsequent field 109. Thus, the liquid is replenished in the exposure zone 100 between the start of adjacent scanning motions, desirably between the end of a first scanning motion and the beginning of the next scanning motion.

Although a similar effect can be achieved using a system of inlets and outlets similar to that illustrated in FIG. 3, there are two disadvantages of using such a system. First, the direction of liquid flow may be difficult to vary continuously (the flow may either need to be horizontal or vertical, as illustrated). Furthermore or alternatively, it may be that valves in the inlets and outlets cannot be switched fast enough to avoid the need to reduce the speed of travel of the substrate W under the projection system PS to accommodate the changes in flow direction. Reducing the speed of travel of the substrate under the projection system PS would affect throughput of the apparatus and therefore be undesirable. Embodiments of the invention address one or more of these, or other, points and can additionally be applied to systems such as those of FIGS. 2-4. In an embodiment, a system without valves imposes a smaller risk of defects, which can be produced by switching of valves.

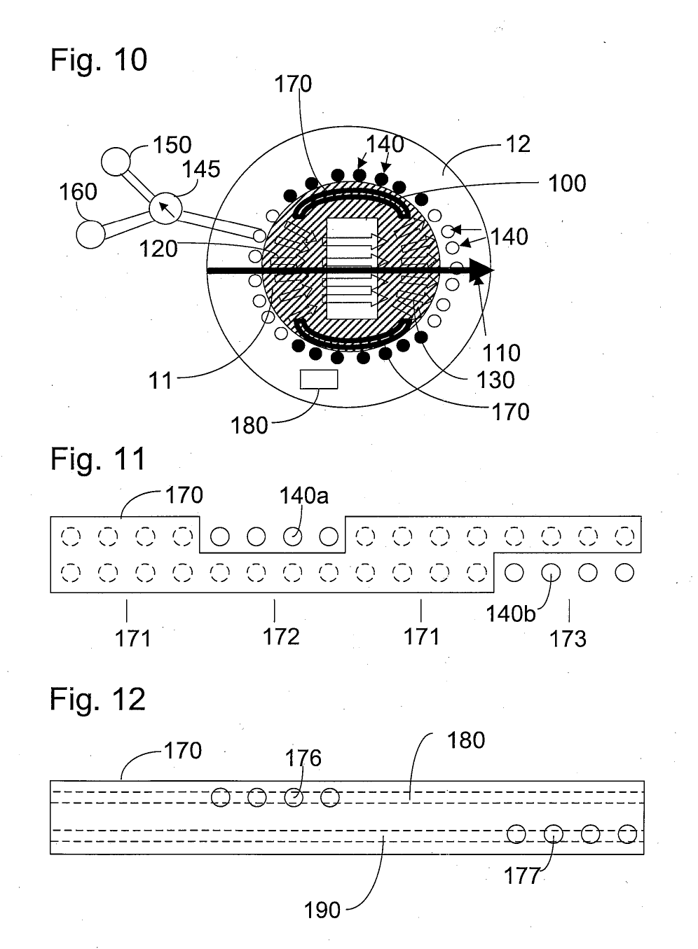

As is illustrated in FIG. 10, in an embodiment of the present invention, a plurality of openings 140 are provided in the body 12 of the fluid handling device. The openings 140 are, in cross-section, circular. However, any other shape may be used. For example, the cross-section may be square or rectangular. The openings are provided in a surface of the body 12. The surface defines the extent of the space 11 to which liquid is provided. The surface faces the space 11. The openings 140 are for the flow therethrough of liquid.

The openings 140 may be inlets for liquid to pass therethrough and enter the space 11. The openings 140 may be outlets for the extraction of liquid therethrough to extract liquid from the space 11. A single opening 140 may be both an inlet or an outlet at different times or may be arranged only to be an inlet or an outlet. If an opening is arranged to be an inlet and an outlet, it will need to be connected to a valve 145 to switch between being in fluid communication with a fluid supply device 150 or with a fluid extraction device 160.

The fluid handling device also comprises at least one barrier 170. The barrier 170 may be considered to be a baffle forming a (rotating) baffle valve. The barrier 170 is moveable relative to the plurality of openings 140. The barrier 170 is constructed and arranged to allow selective preventing of the flow of liquid through selected openings 140 of the plurality of openings 140. That is, as the barrier 170 moves relative to the openings 140 it can block the flow of liquid through an opening 140 by being positioned in front of the opening 140. For example, in the illustration in FIG. 10 which is a schematic plan view of a fluid handling device, the openings 140 on the left and right as illustrated (the unshaded ones) are open and allow fluid flow therethrough (in the case of the openings on the left hand side flow of fluid out of the body 12 into the space 11 and in the case of the openings on the right hand side out of the space 11 into the body 12). However, openings 140 at the top and bottom (the shaded ones) are blocked by the barrier 170 so that no liquid flow is possible between the space 11 and the barrier 12 via those openings 140 that are blocked.

In FIG. 10 the barrier 170 is formed as one piece such that the top and bottom pieces are integral or connected and move together relative to the body 12. However, this may not be the case and the top and bottom parts of the barrier 170 could, for example, be separate pieces. Those pieces could be moved together in synchronization relative to the plurality of openings 140 or they could be moved independently.

The barrier 170 is constructed and arranged to allow liquid to enter the space 11 through openings 140 on a first side (the left hand side of FIG. 10) and to exit the space 11 through openings 140 on a second side (on the right hand side of FIG. 10) of the space 11. That is, the barrier 170 blocks openings 140 on opposite sides of the space 11. The first and second sides are opposite one another. This allows flow of liquid across the space 11 and in particular across the exposure zone 100 as illustrated by arrows 120, 130. Desirably the flow of fluid is smooth, more desirably laminar. By rotating the barrier 170, the position of the first side and the second side is selectable.

The barrier 170 is rotatable in a plane (the plane of the paper of FIG. 10) around an axis substantially parallel to the optical axis of the lithographic projection apparatus. That axis passes through the space 11 and is surrounded by the plurality of openings 140. Optionally that axis is co-axial with the optical axis of the projection system.

The fluid handling device 12 may be provided with a motor 180 to move the barrier 170 relative to the body 12. The motor 180 may work on any principle.

Referring back to FIG. 8, it can be seen that as the substrate changes direction of movement under the projection system (illustrated by arrows 250), the barrier 170 rotates so that the flow of liquid through the space 11 changes direction (indicated by arrows 260) so that the flow direction remains in substantially the same direction as movement of the substrate W under the projection system PS (and the fluid handling device 12 which is substantially fixed in position relative to the projection system PS, at least in the X-Y direction).

The change in flow direction is achieved by rotating the barrier 170 relative to the openings 140 (which are not illustrated in FIG. 8). Therefore, it can be seen that the use of a barrier 170 to block selected ones of openings 140 can result in a continuous change in direction of the flow of liquid. This is an advantage over a system which relies on valves switching between a limited number of openings having an in-flow or an out-flow of fluid out of them.

The rotation of the barrier 170 is controlled by a controller 300 which controls the position of the barrier 170 relative to the openings 140. The control is based on the direction of relative movement between substrate W and the optical axis of the immersion lithographic apparatus. As explained above, helping to ensure that the flow is substantially parallel to the direction of relative movement between the substrate and the optical axis of the immersion apparatus means that liquid may be provided and extracted from the space 11 through the openings 140 at a rate such that liquid in the exposure zone 100 in the space 11 is replenished between the start of adjacent scanning motions 108, 109. The flow rate may also be controlled by the controller 300. The controller 300 may be used to control the flow rate of liquid through the openings 140 and the direction of flow through the openings 140.

A further embodiment will now be described with reference to FIG. 11. As will be appreciated, the embodiment of FIG. 10 has each opening 140 acting both as an inlet and an outlet for liquid into and out of the space 11. This involves the presence of a valve 145 to switch between fluid communication between the opening 140 and a fluid supply device 150 and a fluid extraction device 160. FIG. 11 shows schematically an embodiment in which first openings 140a are provided for the provision therethrough of liquid into the space 11 and second openings 140b are provided for the provision of fluid out of the space 11. In one embodiment the first and second openings 140a, 140b may be placed one above the other. However, other arrangements are possible.

FIG. 11 is a schematic illustration of openings 140a, 140b in the body 12 of the fluid handling device on which is superimposed a barrier 170 according to the embodiment of FIG. 11. In the view of FIG. 11 all of the openings 140 surrounding the space 11 and the barrier 170 surrounding the space 11 have been “unwound” so that in practice the left hand edge of the barrier 170 as illustrated in FIG. 11 and the right hand edge of the barrier as illustrated in FIG. 11 would be next to each other. In this embodiment, the barrier 170 has first and second portions 171 in which both of pairs of adjacent first and second openings are blocked. It also has a third portion 172 in which only the first openings 140a of adjacent vertical pairs of openings are blocked and a fourth portion 173 in which only the second openings 140b of adjacent vertical pairs of openings are blocked. The first and second portions 171 are diametrically opposite each other as are the third and fourth portions 172,173. This arrangement means that liquid will flow into the space 11 through the third portion 172 and out through the fourth portion 173. The orientation of the barrier 170 therefore determines the direction of liquid flow. If the barrier 170 is oriented such that the third and fourth portions 172,173 are aligned with the positive and negative X directions, liquid will flow in the X direction.

Thus, the barrier 170 is constructed and arranged to allow flow through the first openings 140a in third portion 172 of a boundary of the space 11 and preventing flow through second openings 140b in the same portion 172 or vice versa. The barrier 170 may be continually moved relative to the openings 140 so that flow across the space 11 in any desired direction is achievable. No switching between the fluid supply device 150 and fluid extraction device 160 is required and the first openings 140a may continually be in fluid communication with the fluid supply device 150 and the second openings 140b may always be in fluid communication with the fluid extraction device 160.

FIG. 12 illustrates a further embodiment which is similar to the embodiment of FIG. 11. The embodiment of FIG. 12 is a further simplification in that the body 12 need not be provided with a plurality of discrete openings 140a for providing liquid to the space or a plurality of discrete openings 140b for taking liquid out of the space 11. Instead, a chamber which is in communication with the first openings 140a in the embodiment of FIG. 11 may simply have one opening 180 (e.g. a missing side wall) which extends around the periphery (e.g., circumference) of the space 11. The barrier 170 is then provided with through holes 176 associated with the opening 180. By moving the position of the barrier 170 relative to the body 12 the position of the through holes 176 relative to the opening 180 can be adjusted. Thereby the position of introduction of liquid into the space 11 can be selected.

A second opening 190 in fluid communication with a chamber (which is in communication with the second openings 140b in the FIG. 11 embodiment) is provided in the body 12 to remove liquid from the space 11. Corresponding through holes 177 are provided in the barrier 170 to select the part of the opening 190 through which liquid is removed from the space 11. Therefore the through holes 176, 177 are arranged to allow the flow of fluid through a selected part of an associated opening 180, 190.

The openings 180,190 may extend around the periphery of the space 11. The single openings 180,190 may each comprise a plurality of openings, at expense of complexity of the arrangement. In that case the through holes 176, 177 are arranged to allow the flow of fluid through a selected part of an associated opening and/or a selected opening of the plurality of openings, depending upon the relative size of the openings and the through holes.

In an embodiment the plurality of openings 176 are comprised of a single opening. In an embodiment the plurality of openings 177 are comprised of a single opening. The openings 176 comprise a first set of through holes and the openings 177 comprise a second set of through holes. The first set of through holes allow for provision therethrough of fluid into the space 11. The second set of through holes 177 allow for the provision (or extraction) therethrough of fluid out of the space 11. The first set and second set of through holes are on opposite sides of the space 11. Thereby flow of fluid across the space 11 in any direction can be achieved.

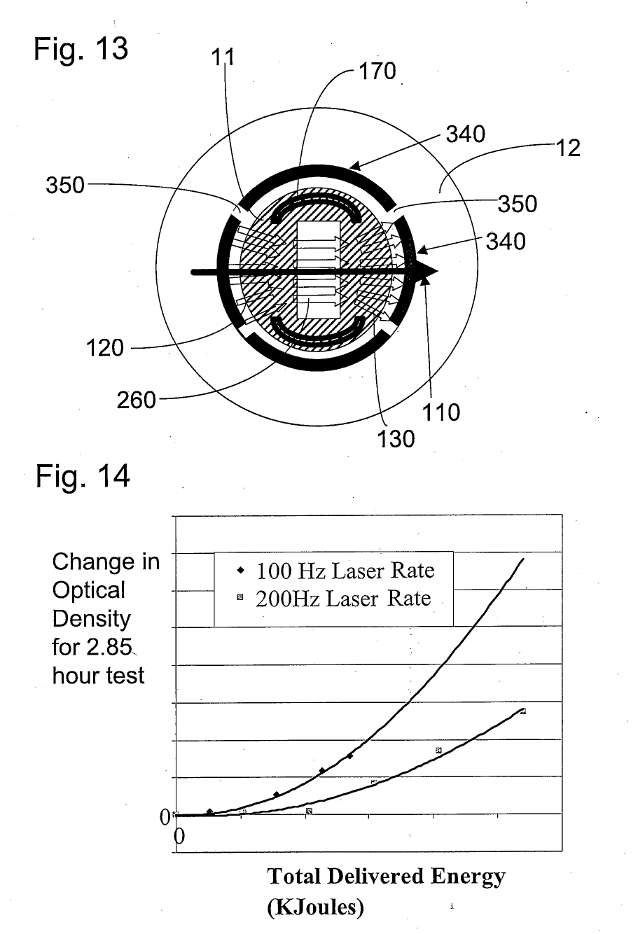

FIG. 13 illustrates a further embodiment. In this embodiment the openings are not circular but are slits or slots 340. Four slits are provided. If the fluid handing device is split, in plan, into quadrants (i.e. four wedges), each quadrant is associated with one of the slots 340. The direction of liquid flow 260 through the space 11 is rotated as the barrier 170 is rotated. This progressively opens and closes sections of the slots 340. Support bars 350 that support the slots 340 are located in the area of the corners of the exposure zone 100 (which corresponds to the exposure slit) to reduce or minimize turbulence effects.

The use of a high n immersion liquid or fluid is also problematic because the surface of the last optical element of the projection system is in contact with the liquid/fluid. As UV radiation exposes the liquid/fluid, the final element of the projection system PS becomes contaminated with a carbon deposit which results from the UV illumination of the liquid/fluid. The deposit results in a decrease in optical transmission and illumination uniformity suffers. As a result the final element of the projection system PS should be cleaned periodically. A conventional apparatus uses a single laser radiation source which produces pulses at approximately 6 kHz. Breakdown of a high n immersion fluid (which mainly comprises a hydrocarbon) can be reduced by reducing the maximum energy of the laser to below 0.3 mJ/cm². Desirably the pulse energy is reduced to below 0.25, 0.2 or 0.15 mJ/cm². It is proposed to reduce the optics contamination rate by reducing the peak pulse energy from the laser while retaining the desired dose delivery rate. It is proposed to reduce the laser pulse energy by using one, or multiple, of the following methods while maintaining total exposure energy. In order to retain the desired dose delivery rate to the substrate W, one or several of the following methods may be employed. First, the pulse rate of the apparatus may be increased. For example, the pulse rate may be increased to greater than 8,000 Hz, desirably greater than 9,000 or 10,000 Hz. This can be achieved by providing two or more laser radiation sources. The beam PB of the apparatus may comprise interlaced pulses from the at least two sources. A, second option is to increase the laser pulse repetition rate of a single radiation source (albeit at lower pulse energy). A third option is to extend the duration of a pulse (called pulse stretching), for example to greater than 300 nanoseconds. Desirably the duration of each pulse is greater than 350 or 400 nanoseconds. Pulse stretching can be extended from 2× or 3× to >5× by passing the laser beam through high efficiency pulse stretcher modules that operate on the delay line principle. This reduces the peak UV pulse energy to <60% of the conventional peak pulse energies. The exposure dose for the resist in the lithographic tool is then delivered with reduced peak pulse energy (<60%). This can significantly reduce the optics contamination rate because the contamination rate is a non linear function of the peak pulse energy.

FIG. 14 is a graph which illustrates the improvement achieved by an embodiment of the present invention. Two experiments were carried out in which during a period of 2.85 hours the same total energy was applied using a laser at a pulse rate of 100 Hz as a laser with a pulse rate of 200 Hz. The X axis shows the total delivered energy and the Y axis illustrates the change in optical density of a member simulating the final element of a projection system PS.

As can be seen, for the laser with the lower pulse rate, a greater change in optical density is achieved for any given total amount of delivered energy. In the experiment of FIG. 14 the power of the 200 Hz laser is half that of the 100 Hz laser (to achieve the same dose rate). However, the same results can be expected by varying the pulse duration while maintaining the same pulse rate.

It appears that the above effect is related to the balance between the desorption rate of damaged molecules from the optics surface and the rate of formation. For narrow, high energy UV pulses the energy delivery is too fast to allow desorption of a damaged molecule, before it is hit by another damaging photon. Multiple photon hits on a molecule reduce its solubility (strip hydrogen atoms and turn it into carbon).

The use of one or more of these techniques is particularly suitable for a high NA immersion apparatus. Such a high NA immersion apparatus typically uses a final element made of material selected from the group comprising LuAG and a spinel. Typically the final element of a high NA immersion apparatus does not comprise quartz. The refractive index of a high NA immersion liquid is typically greater than 1.4 or greater than 1.5 or greater than 1.6 (water has a refractive index of 1.437 at a wavelength of 193 nm) and usually the immersion liquid is a hydrocarbon immersion liquid.

As will be appreciated, any of the above described features can be used with any other feature and it is not only those combinations explicitly described which are covered in this application.

In an embodiment, there is provided a fluid handling device for an immersion lithographic apparatus, the fluid handling device comprising: a body with a surface surrounding a space for fluid; a plurality of openings for the flow of fluid therethrough defined in the surface; and a barrier moveable relative to the body to selectively allow or prevent flow of fluid through a selected opening, or a selected part of an opening, of the plurality of openings.

The barrier may be constructed and arranged to allow fluid to enter the space through an opening on a first side of the space and to exit the space through an opening on a second side of the space, the first and second sides being opposite one another.

The position of the first side and the second side may be selectable dependent upon the position of the barrier relative to the plurality of openings.

The barrier desirably, in use, blocks openings on opposite sides of the space.

The barrier may be rotatable in a plane around an axis orthogonal to the plane, which axis passes through the space and is surrounded by the plurality of openings, desirably the barrier is rotatable in the plane around the axis without undergoing displacement.

The plurality of openings may comprise at least four openings, in plan the space being divisible into quadrants and each quadrant being associated with at least one opening.

A plurality of through holes may be defined in the barrier, each through hole being arranged to allow the flow of fluid through a selected part of an associated opening, or a selected opening, of the plurality of openings.

The plurality of through holes may comprise through holes on opposite sides of the space.

The plurality of openings may comprise: a first opening or openings for the provision therethrough of fluid into the space and associated with a first set of the plurality of through holes, and a second opening or openings for the provision therethrough of fluid out of the space and associated with a second set of the plurality of through holes.

The first set of through holes and second set of through holes may be on opposite sides of the space.

The plurality of openings may comprise first openings for the provision therethrough of fluid into the space and second openings for the provision therethrough of fluid out of the space.

The barrier may be constructed and arranged to allow flow through the first openings in a portion of a boundary of the space and to prevent flow through second openings in the portion, or vice versa.

The plurality of openings may surround the space.

The device may comprise a motor to move the barrier relative to at least one opening.

The barrier may be a single piece or several pieces which are moved together relative to the plurality of openings.

An immersion lithographic apparatus may comprise a fluid handling device as above.

The apparatus may further comprise a controller to control a position of the barrier relative to the plurality of openings based on the direction of relative movement between a substrate and an optical axis of the immersion lithographic apparatus.

The controller may control the position of the barrier relative to the plurality of openings such that fluid flows through the space in a direction substantially parallel to the direction of relative movement between the substrate and the optical axis of the immersion lithographic apparatus, desirably the direction of fluid flow in the space is in substantially the same direction as the direction of relative movement between the substrate and the optical axis.

The apparatus may further comprise a fluid supply device to provide fluid to the space through an opening selected by the position of the barrier relative to the plurality of openings.

The apparatus may further comprise a fluid extraction device to extract fluid from the space through an opening selected by the position of the barrier relative to the plurality of openings.

The apparatus may be arranged to provide and extract fluid from the space through at least one opening at a rate such that fluid in an exposure zone in the space, in which exposure zone fluid is irradiated by a beam of radiation during scanning, is replenished between the start of adjacent scanning motions.

A peak energy of a beam of radiation produced by the apparatus and projected toward the substrate may be less than 0.3 mJ/cm².

A pulse rate of a beam of radiation produced by the apparatus and projected toward the substrate may be greater than 8,000 Hz.

The apparatus may be arranged to provide a beam of radiation in pulsed form and projected toward the substrate in which the duration of each pulse is greater than 300 nanoseconds.

The apparatus may comprise at least two laser radiation sources, wherein a beam of radiation for imaging of a substrate comprises interlaced pulses from the at least two sources.

In an embodiment an immersion lithographic apparatus is arranged to provide and extract fluid from a space through an opening at a rate such that fluid in an exposure zone in the space in which exposure zone fluid is irradiated by a beam of radiation during scanning is replenished between the start of adjacent scanning motions.

In an embodiment an immersion lithographic apparatus comprises a source of radiation to irradiate with a beam of radiation a substrate through an immersion liquid, the source of radiation configured to produce the beam of radiation with a peak energy of less than 0.3 mJ/cm².

A pulse rate of the beam of radiation may be greater than 8,000 Hz.

The apparatus may be arranged to provide the beam of radiation in pulsed form in which the duration of each pulse is greater than 300 nanoseconds.

The apparatus may comprise at least two laser radiation sources, wherein the beam of radiation comprises interlaced pulses from the at least two sources.

The apparatus may comprise a projection system having a final element made of a material selected from the group comprising LuAG or Spinel.

The apparatus may comprise a projection system, wherein the final element of the projection system does not comprise quartz.

The immersion liquid may comprise a high refractive index immersion liquid, desirably with a refractive index of greater than 1.4 or greater than 1.5 or greater than 1.6.

The immersion liquid may be a hydrocarbon immersion liquid.

In an embodiment, a device manufacturing method, comprises projecting a patterned beam of radiation onto a substrate through a fluid provided in a space adjacent the substrate, wherein fluid is provided and extracted from the space at such a rate that fluid in an exposure zone in the space, in which exposure zone fluid is irradiated during scanning, is replenished between the start of adjacent scanning motions.

In an embodiment, a device manufacturing method, comprises projecting a patterned beam of radiation onto a substrate through a fluid provided in a space adjacent the substrate, wherein a plurality of openings are defined in a surface of a body which surface faces the space and a direction of flow of fluid through the space is adjusted by moving a barrier relative to the plurality of openings.

In an embodiment, a device manufacturing method, comprises projecting a patterned beam of radiation onto a substrate through a fluid provided in a space adjacent the substrate, wherein the patterned beam of radiation has a peak energy of less than 0.3 mJ/cm².

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of or about 365, 248, 193, 157 or 126 nm). The term “lens”, where the context allows, may refer to any one or combination of various types of optical components, including refractive and reflective optical components.

While specific embodiments of the invention have been described above, it will be appreciated that the invention may be practiced otherwise than as described. For example, the embodiments of the invention may take the form of a computer program containing one or more sequences of machine-readable instructions describing a method as disclosed above, or a data storage medium (e.g. semiconductor memory, magnetic or optical disk) having such a computer program stored therein. Further, the machine readable instruction may be embodied in two or more computer programs. The two or more computer programs may be stored on one or more different memories and/or data storage media.

The controllers described herein may each or in combination be operable when one or more computer programs are read by one or more computer processors located within at least one component of the lithographic apparatus. The controllers may each or in combination have any suitable configuration for receiving, processing, and sending signals. One or more processors are configured to communicate with the at least one of the controllers. For example, each controller may include one or more processors for executing the computer programs that include machine-readable instructions for the methods described above. The controllers may include data storage medium for storing such computer programs, and/or hardware to receive such medium. So the controller(s) may operate according the machine readable instructions of one or more computer programs.

One or more embodiments of the invention may be applied to any immersion lithography apparatus, in particular, but not exclusively, those types mentioned above and whether the immersion liquid is provided in the form of a bath, only on a localized surface area of the substrate, or is unconfined. In an unconfined arrangement, the immersion liquid may flow over the surface of the substrate and/or substrate table so that substantially the entire uncovered surface of the substrate table and/or substrate is wetted. In such an unconfined immersion system, the liquid supply system may not confine the immersion fluid or it may provide a proportion of immersion liquid confinement, but not substantially complete confinement of the immersion liquid.

A liquid supply system as contemplated herein should be broadly construed. In certain embodiments, it may be a mechanism or combination of structures that provides a liquid to a space between the projection system and the substrate and/or substrate table. It may comprise a combination of one or more structures, one or more fluid openings including one or more liquid openings, one or more gas openings or one or more openings for two phase flow. The openings may each be an inlet into the immersion space (or an outlet from a fluid handling structure) or an outlet out of the immersion space (or an inlet into the fluid handling structure). In an embodiment, a surface of the space may be a portion of the substrate and/or substrate table, or a surface of the space may completely cover a surface of the substrate and/or substrate table, or the space may envelop the substrate and/or substrate table. The liquid supply system may optionally further include one or more elements to control the position, quantity, quality, shape, flow rate or any other features of the liquid.

The descriptions above are intended to be illustrative, not limiting. Thus, it will be apparent to one skilled in the art that modifications may be made to the invention as described without departing from the scope of the claims set out below.

1. A fluid handling device for an immersion lithographic apparatus, the fluid handling device comprising:
a body with a surface surrounding a space for fluid;
a plurality of openings for the flow of fluid therethrough defined in the surface; and
a barrier moveable relative to the body to selectively allow or prevent flow of fluid through a selected opening, or a selected part of an opening, of the plurality of openings.

2. The fluid handling device of claim 1, wherein the barrier is constructed and arranged to allow fluid to enter the space through an opening on a first side of the space and to exit the space through an opening on a second side of the space, the first and second sides being opposite one another, wherein the position of the first side and the second side is selectable dependent upon the position of the bather relative to the plurality of openings.

3. The fluid handling device of claim 1, wherein the bather, in use, blocks openings on opposite sides of the space.

4. The fluid handling device of claim 1, wherein the bather is rotatable in a plane around an axis orthogonal to the plane, which axis passes through the space and is surrounded by the plurality of openings, desirably the bather is rotatable in the plane around the axis without undergoing displacement.

5. The fluid handling device of claim 1, wherein the plurality of openings comprise at least four openings, in plan the space being divisible into quadrants and each quadrant being associated with at least one opening.

6. The fluid handling device of claim 1, wherein a plurality of through holes are defined in the bather, each through hole arranged to allow flow of fluid through a selected part of an associated opening, or a selected opening, of the plurality of openings.

7. The fluid handling device of claim 7, wherein the plurality of through holes comprise through holes on opposite sides of the space.

8. The fluid handling device of claim 7, wherein the plurality of openings comprise: a first opening or openings for the provision therethrough of fluid into the space and associated with a first set of the plurality of through holes, and a second opening or openings for the provision therethrough of fluid out of the space and associated with a second set of the plurality of through holes.

9. The fluid handing device of claim 1, wherein the plurality of openings comprise first openings for the provision therethrough of fluid into the space and second openings for the provision therethrough of fluid out of the space.

10. The fluid handling device of claim 1, wherein the barrier is a single piece or several pieces which are moved together relative to the plurality of openings.

11. An immersion lithographic apparatus comprising a fluid handling device for an immersion lithographic apparatus, the fluid handling device comprising:
a body with a surface surrounding a space for fluid;
a plurality of openings for the flow of fluid therethrough defined in the surface; and
a barrier moveable relative to the body to selectively allow or prevent flow of fluid through a selected opening, or a selected part of an opening, of the plurality of openings.

12. The immersion lithographic apparatus of claim 11, further comprising a controller to control a position of the barrier relative to the plurality of openings based on the direction of relative movement between a substrate and an optical axis of the immersion lithographic apparatus.

13. The immersion lithographic apparatus of claim 12, wherein the controller is configured to control the position of the barrier relative to the plurality of openings such that fluid flows through the space in a direction substantially parallel to the direction of relative movement between the substrate and the optical axis of the immersion lithographic apparatus, desirably the direction of fluid flow in the space is in substantially the same direction as the direction of relative movement between the substrate and the optical axis.

14. The immersion lithographic apparatus of claim 11, further comprising a fluid supply device to provide fluid to the space through an opening selected by the position of the barrier relative to the plurality of openings.

15. The immersion lithographic apparatus of claim 11, further comprising a fluid extraction device to extract fluid from the space through an opening selected by the position of the barrier relative to the plurality of openings.

16. The immersion lithographic apparatus of claim 11, arranged to provide and extract fluid from the space through at least opening at a rate such that fluid in an exposure zone in the space, in which exposure zone fluid is irradiated by a beam of radiation during scanning, is replenished between the start of adjacent scanning motions.

17. The immersion lithographic apparatus of claim 11, wherein a peak energy of a beam of radiation produced by the apparatus and projected toward the substrate is less than 0.3 mJ/cm².

18. The immersion lithographic apparatus of claim 11, wherein a pulse rate of a beam of radiation produced by the apparatus and projected toward the substrate is greater than 8,000 Hz.

19. The immersion lithographic apparatus of claim 11, arranged to provide a beam of radiation in pulsed form and projected toward the substrate in which the duration of each pulse is greater than 300 nanoseconds.

20. The immersion lithographic apparatus of claim 11, comprising at least two laser radiation sources, wherein a beam of radiation to image a substrate comprises interlaced pulses from the at least two sources.

21. A device manufacturing method, comprising projecting a patterned beam of radiation onto a substrate through a fluid provided in a space adjacent the substrate, wherein a plurality of openings are defined in a surface of a body which surface faces the space and a direction of flow of fluid through the space is adjusted by moving a barrier relative to the plurality of openings.
